(19) United States
(12) Patent Application Publication
(10) Pub. No.: US 2006/0100979 A1
(43) Pub. Date: May 11, 2006

(54) Controller for a medical imaging system

(75) Inventors: Michael Venturino, Geneseo, NY (US); Ronald J. Perry, Webster, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/974,334

(22) Filed: Oct. 27, 2004

(51) Int. Cl. G06F 17/30

(52) U.S. Cl. 707/1

(57) ABSTRACT

A controller for a medical imaging system. The controller includes a hand-held unit and a base unit. The hand-held unit, operable by a hand of a user, has a first shape and a first set of user controls for effecting a first set of operations of the medical imaging system. The base unit has a cavity adapted to receive the hand-held unit. The cavity has a second shape which complements the first shape such that, when the hand-held unit is received within the cavity, a control device is formed which can be operated by one hand of a user. The base unit includes a second set of user controls for effecting a second set of operations of the medical imaging system.

### FIELD OF THE INVENTION

The invention relates generally to the field of medical imaging, and in particular to controlling medical imaging systems. More specifically, the invention relates to a controller for a medical imaging system.

### BACKGROUND OF THE INVENTION

Digital medical images can be captured/obtained using a variety of medical imaging systems, for example, using a computed tomography (CT) system, computed radiography (CR) system, or a digital radiography (DR) system. In addition, conventional x-ray can be converted into a digital medical image using a digitizer.

The medical community relies heavily on medical imaging systems for storage and display of these digital medical images. A workstation/computer is an example of a medical imaging system. One particular example is a RIS (radiology information system) workstation which can be used to store, manipulate, and retrieve information for planning, organizing, directing, and controlling administrative activities associated with the provision and utilization of radiology services and facilities. Another particular example is a PACS (picture archive and communication system) workstation which used for picture viewing, image tracking, archiving, retrieval, and communications. Images from multiple medical imaging systems can be directed between diagnostic viewing stations and archive servers. An example of a PACS system is the Kodak MiniPACS for Mammography System which is a high volume diagnostic workstation for use in storing, retrieving, distributing, and presenting patient study data and images.

Control means are available for controlling the operation of such medical imaging systems. However, there exists a need for a user-friendly controller that provides for flexible, efficient, and easy use of medical imaging systems.

The present invention provides a controller for a medical imaging system which is user-friendly and provides flexibility in method of use.

### SUMMARY OF THE INVENTION

An object of the present invention is to provide a controller for a medical imaging system.

Another object of the present invention is to provide such a controller which promotes ready use of the medical imaging system.

A further object of the present invention is to provide such a controller which is user-friendly.

Yet a further object of the present invention is to provide such a controller which allows flexibility in method of use.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a controller for a medical imaging system having a hand-held unit and a base unit. The hand-held unit has a first shape and can be operated by one hand of a user. The base unit has a cavity adapted to receive the hand-held unit. The cavity has a second shape which complements the first shape such that, when the hand-held unit is received within the cavity, a control device is formed which can be operated by one hand of a user. The hand-held unit includes a first set of user controls for effecting a first set of operations of the medical imaging system and the base unit includes a second set of user controls for effecting a second set of operations of the medical imaging system.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 shows a diagrammatic view of medical imaging system in use with a controller in accordance with the present invention.

FIG. 2 shows a perspective view of a controller in accordance with the present invention including a hand-held unit and a base unit.

FIG. 3 shows a perspective view of the controller in accordance with the present invention with the hand-held unit disposed within a cavity of the base unit.

FIG. 4 shows a block diagram illustrating operations of the medical imaging system that can be controlled using the user control members of the controller.

FIG. 5 shows a diagrammatic side view of the hand-held unit in accordance with the present invention.

FIG. 6 shows a diagrammatic back-side view of the hand-held unit of FIG. 5.

FIG. 7 shows several views of another configuration of the controller of the present invention.

FIG. 8 shows several views of yet another configuration of the controller of the present invention.

FIG. 9 shows a diagrammatic top view of yet another configuration of the controller of the present invention.

### DETAILED DESCRIPTION OF THE INVENTION

The following is a detailed description of the preferred embodiments of the invention, reference being made to the drawings in which the same reference numerals identify the same elements of structure in each of the several figures.

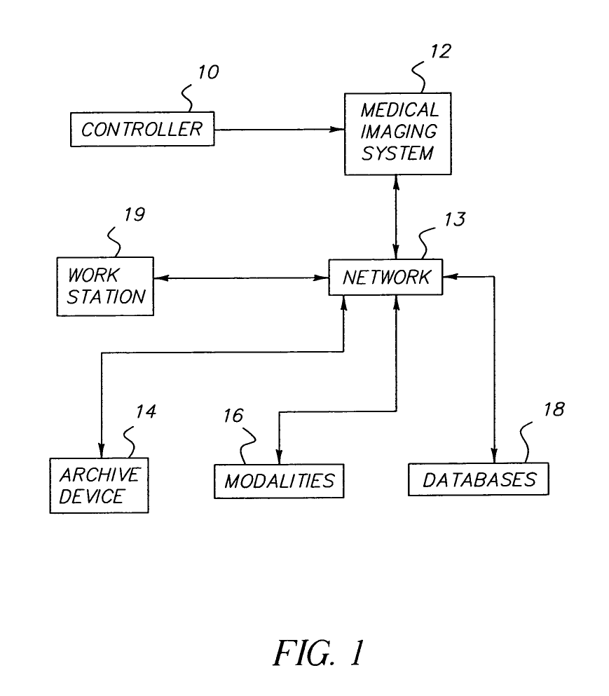

Referring to FIG. 1, a controller 10 in accordance with the present invention is used to control a medical imaging system 12. Medical imaging system 12 can be connected to a network for communication 13 with other devices, for example, an archive storage device 14, one or more modalities 16, and one or more databases 18, and one or more workstations 19 where images can be viewed.

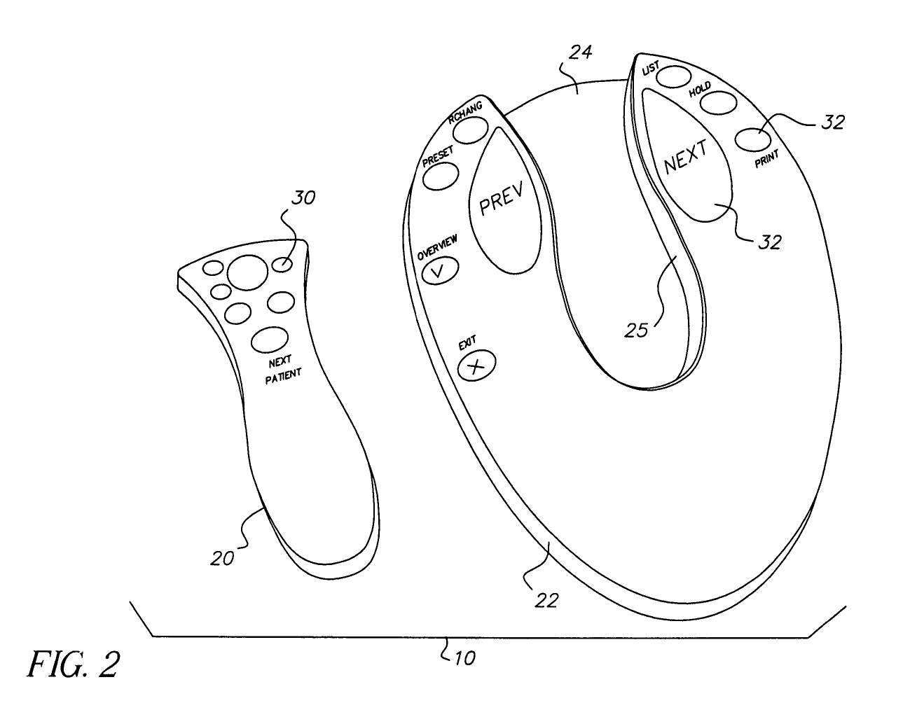

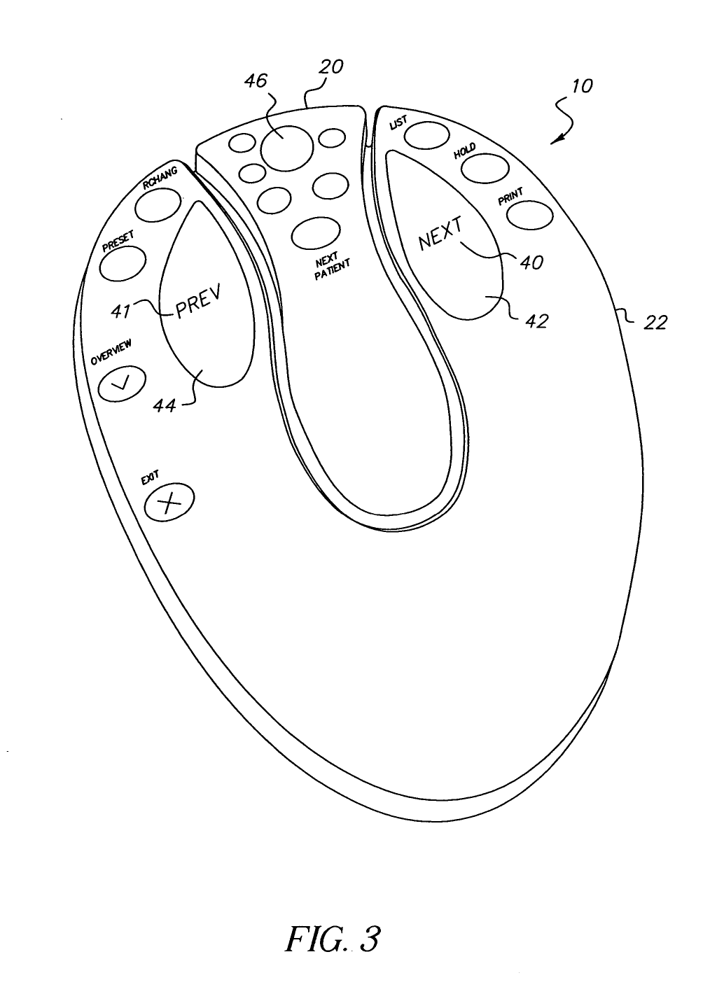

Controller 10, in accordance with the present invention, is more particularly illustrated in FIGS. 2 and 3. Controller 10 includes a hand-held unit 20 and a base unit 22. Hand-held unit 20 has a first shape, as best shown in FIG. 2, which provides for handling by a user with one hand. Hand-held unit 20 includes at least one user control member 30 for controlling medical imaging system 12. These user control members will be more particularly described below. The user/operator can effect operation of medical imaging system 12 using the user control members of hand-held unit 20.

Base unit 22 has a cavity 24 adapted to receive hand-held unit 20. Cavity 24 is configured to have a second shape that complements the first shape of hand-held unit 20. As such, when hand-held unit 20 is received within cavity 24 of base unit 22, a substantially continuous surface is formed.

Base unit 20 also includes at least one user control member 32 for controlling medical imaging system 12. These user control members can be operated by a user when hand-held unit 20 is not received within cavity 24. Likewise, the user control members of hand-held unit 20 can be operated by a user when hand-held unit is not received within cavity 24. When hand-held unit 20 is received within cavity 24, controller 10 can be operated by one hand of a user. That is, the user control members on both hand-held unit 20 and base unit 22 can be operated by a hand of a user.

Hand-held unit 20 may require the use of batteries for operation. Therefore, it may be desirable for base unit 22 to include an electrical connector 25 disposed within cavity 24 which can be used to recharge the batteries disposed within hand-held unit 20. Hand-held unit 20 would include a matable connector such that, when hand-held 20 is received within cavity 24, the hand-held unit's connector would mated with the base unit's electrical connector to effect charging of a battery disposed within the hand-held unit.

Control members 30,32 can include a corresponding label/text adjacent/proximate the particular user control member so as to assist the user in operation of controller 10. For example, referring to FIG. 3, a label 40 of “NEXT” is shown on control member 42 configured as a button pressable/clickable by a user. This “NEXT” button can be intended to control the display of the next stage. More particularly, a user control member for next stage could display the next stage of the currently applied display protocol. For example, for mammography, each stage is typically a separate viewbox. The stage can include one, two, four, or eight images.

Similarly, referring to FIG. 3, a label 41 of “PREV” is shown on control member 44 configured as a button actuatable by a user. This “PREV” button can be intended to control the previous stage of the currently applied display protocol. Again, each stage is typically a separate viewbox.

A control member can be configured as a trackball 46 for scrolling and selecting options displayed on a display of the medical imaging system.

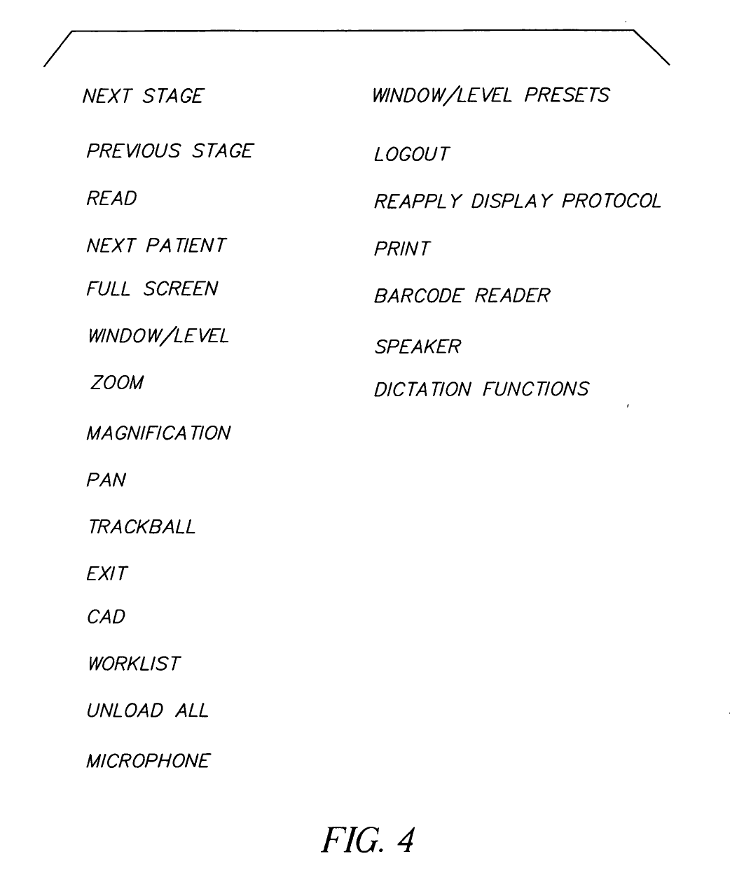

FIG. 4 shows a block diagram illustrating exemplary operations of the medical imaging system that can be controlled using user control members 30,32 of the controller of the present invention.

A user control member for “read” could mark the current study as “read” and load the next study into a worklist.

A user control member for “full screen” could toggle the system in/out of full screen mode. When in the full screen mode, an image is displayed using a full resolution of the display monitor. When the user logs in, the default state for the system could be the full screen mode.

A user control member for “next patient” could access the digital medical images for a next patient.

A user control member for “Window/level presets” could actuate presettings. For example, a first preset could apply a first window/level preset to the displayed image “underneath” the cursor. A second preset could apply a second window/level preset to the image underneath the cursor. Similarly, an automatic preset could apply an automatic window/level preset to the image underneath the cursor.

A user control member for “logout” could terminate the application/session and log the user off the system and close down the application.

A user control member for “Reapply display protocol” could display the medical images in their original order and arrangement.

A user control member for “print” could cause the printing of the currently displayed image.

A user control member for “Full screen” could remove all menus and toolbars, displaying only the medical image.

A user control member for “Barcode reader” could cause the activation of a bar code reader in communication with the medical imaging system. Upon activation, information from the bar code would be read. The bar code reader could be integral to hand-held unit 20 or separate form hand-held unit 20.

A user control member for “speaker” could cause the activation of a speaker. Similarly, a user control member for “microphone” could cause the activation of a microphone, and consequently, record information. If such a function is provided, additional dictation functions of record/play/stop/pause may be desired.

A user control member for “Window/level”, “Pan”, “Zoom”, and “magnify” (or “magnification”) can also be available.

The user control member for “Window/level” could control a selected state and a de-selected state/mode. That is, actuating this control member could place the system in a selected state and actuating the control member again would place the system in a de-selected state. Selection of this control member can place a trackball and the system in a window/level mode. If the pan, zoom, or magnify mode has been previously selected (using a user control member), that mode could be automatically de-selected. A pointer/cursor on the medical imaging system could change to the window/level mode if it is not already. When in window/level mode, manipulation of the trackball could adjust the window and level responsive to the direction/motion of the trackball movement. De-selection of the window/level mode can take the system out of window/level mode.

The user control member for “zoom” can control a selected state and a de-selected state/mode. That is, actuating this control member could place the system in a selected state and actuating the control member again would place the system in a de-selected state. Selection of this control member can place a trackball and the system in a zoom mode. If the pan, window/level, or magnify mode has been previously selected (using a user control member), that mode could be automatically de-selected. A pointer/cursor on the medical imaging system could change to the zoom mode if it is not already. When in zoom mode, manipulation of the trackball could enlarge or reduce (in size) the displayed image responsive to the direction of the trackball movement. For example, if the trackball motion is in a first direction (for example, upward), the displayed image could be enlarged. Similarly, if the trackball motion is in a second direction (opposite the first direction, for example, downward), the displayed image could be reduced in size. De-selection of the zoom mode can take the system out of zoom mode.

The user control member for “magnify” could control a selected state and a de-selected state/mode. That is, actuating this control member could place the system in a selected state and actuating the control member again would place the system in a de-selected state. Selection of this control member can place a trackball and the system in a magnify/magnification mode and display a region of interest view box. If the pan, zoom, or window/level mode has been previously selected (using a user control member), that mode could be automatically de-selected. A pointer/cursor on the medical imaging system could change to the magnify mode if it is not already. When in magnify mode, manipulation of the trackball could move the region of interest view box in a direction responsive to the direction/motion of the trackball movement. De-selection of the magnify mode can take the system out of magnify mode.

The user control member for “pan” could control a selected state and a de-selected state/mode. That is, actuating this control member could place the system in a selected state and actuating the control member again would place the system in a de-selected state. Selection of this control member can place a trackball and the system in a pan mode. If the magnify, zoom, or window/level mode has been previously selected (using a user control member), that mode could be automatically de-selected. A pointer/cursor on the medical imaging system could change to the pan mode if it is not already. When in pan mode, manipulation of the trackball could cause panning of the displayed image in a direction responsive to the direction/motion of the trackball movement. De-selection of the pan mode can take the system out of pan mode.

A user control member for “exit” could initiate a procedure to exit/end the particular application. If a study is displayed, the user can be prompted to indicate whether or not they wish to confirm the current study.

A user control member for “CAD” could actuate/de-actuate the display of CAD (computer aided detection) markers on the displayed image.

A user control member for “Worklist” could display the worklist without unloading or changing the mode of the current study.

A user control member for “unload all” could unload all the studies with any change in study mode and display the worklist.

User control members can also be positioned on a back-side of hand-held unit 20. As such, when the user is holding hand-held unit, such a user control member can be activated by the user's hand. However, when hand-held unit 20 is received within base unit 22, such a back-side positioned control member would not be accessible. If such a control member is desired for operation when unit 20 is received within unit 22, the particular control member can be made available on base unit 22.

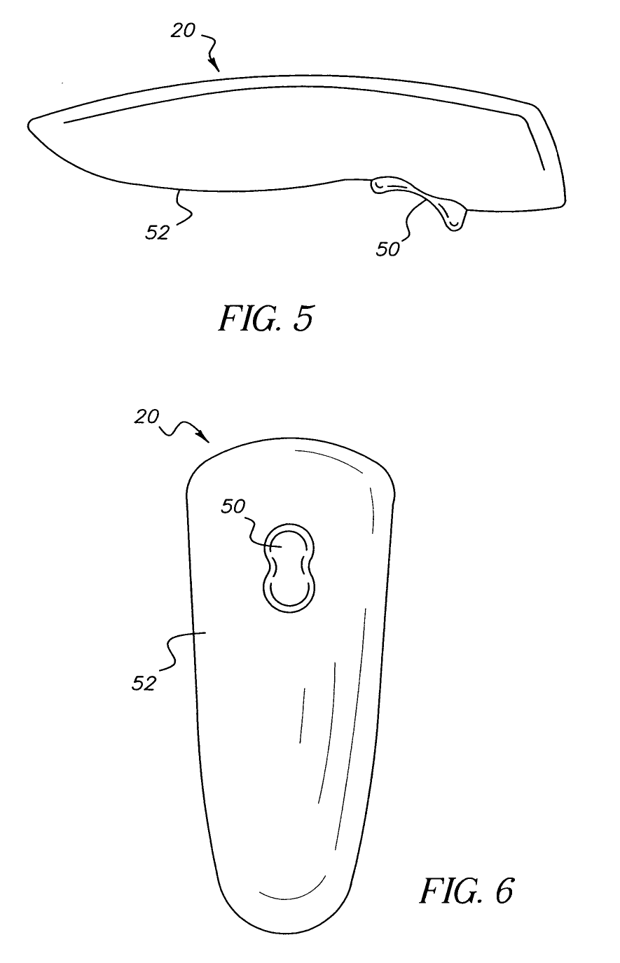

For example, referring to FIGS. 5 and 6, a “NEXT” and “PREV” control member(s) 50 may be positioned on a back-side 52 (i.e., a side adapted to be disposed within cavity 24) of hand-held unit 20. Control members for “NEXT” and “PREV” can also be positioned on base unit 22, as shown in FIG. 3 as elements 42 and 44, respectively. With such an arrangement, member 50 is not accessible when hand-held unit 20 is mated with base unit 22, however, members 42, 44 are accessible when hand-held unit 20 is mated with base unit 22. Accordingly, some operations of hand-held unit 20 and base unit 22 can overlap. However, when mated, preferably all functionality is provided, and each operable user control member provides a separate/different operation.

It may be desirable, from an ergonomics stand point, to position the user control members in a particular location and/or order on hand-held unit 20 and/or base unit 22. For example, user control members which are often typically used, might be positioned in a location readily accessible for activation by the user, whereas a user control member which is not typically often used might be positioned in a more remote location of the hand-held unit and/or base unit.

It may also be desirable to group the user control members in some particular manner. For example, hand-held unit 20 might include user control members directed to manipulating the display of an image whereas base unit 22 might include user control members directed to administrative functions of the medical imaging system.

Accordingly, preferably, hand-held unit 20 includes a first set of user control members for effecting a first set of operations of the medical imaging system and base unit 22 includes a second set of user control members for effecting a second set of operations of the medical imaging system.

In a preferred embodiment, the first set of user control members controls the manipulation of an image displayed on a display of the medical imaging system (for example, zoom, pan, magnify) while the second set of user control members controls database and administration information (for example, print, logout, reapply display protocol).

So as to reduce the number of user control members on each unit, it is preferred that the first set of user controls differs from the second set of user controls when the hand-held unit is received within the cavity. As such, each user control member available for operation by the user provides a unique control function. This can be accomplished by the position of the control member on the unit. For example, the “NEXT” and “PREV” control members, may be positioned on the back-side of hand-held unit 20. These control members can also be positioned on base unit 22, as shown in FIG. 3, such that they are accessible when hand-held unit 20 is mated with base unit 22. Accordingly, when hand-held unit 20 is received within base unit 22, only one set (i.e. the base unit set) of the “NEXT” and “PREV” control members is available for operation by the user.

Controller 10 can be physically or non-physically associated with the medical imaging system. For example, it may be desired to tether base unit 22 to the medical imaging system so as to not misplace the base unit. Alternatively, controller 10 can be wirelessly associated with the medical imaging system using wireless communication means known to those skilled in the art.

Hand-held unit 20 can be configured to transmit information to the medical imaging system through base unit 22 to effect the first set of operations, or alternatively, hand-held unit 20 can be configured to transmit information directly to the medical imaging system.

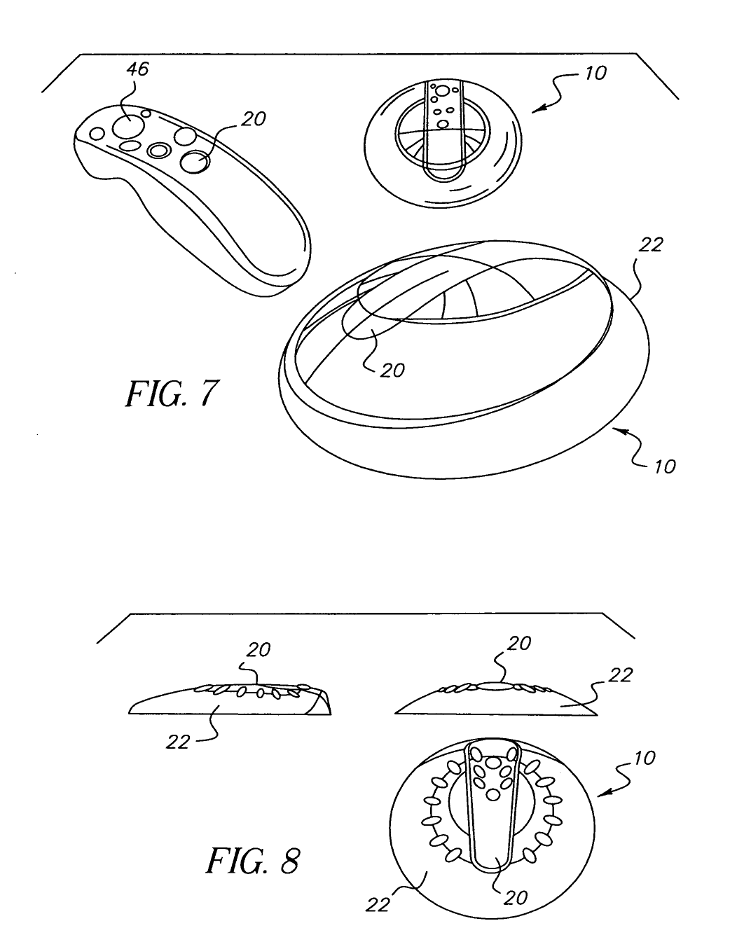

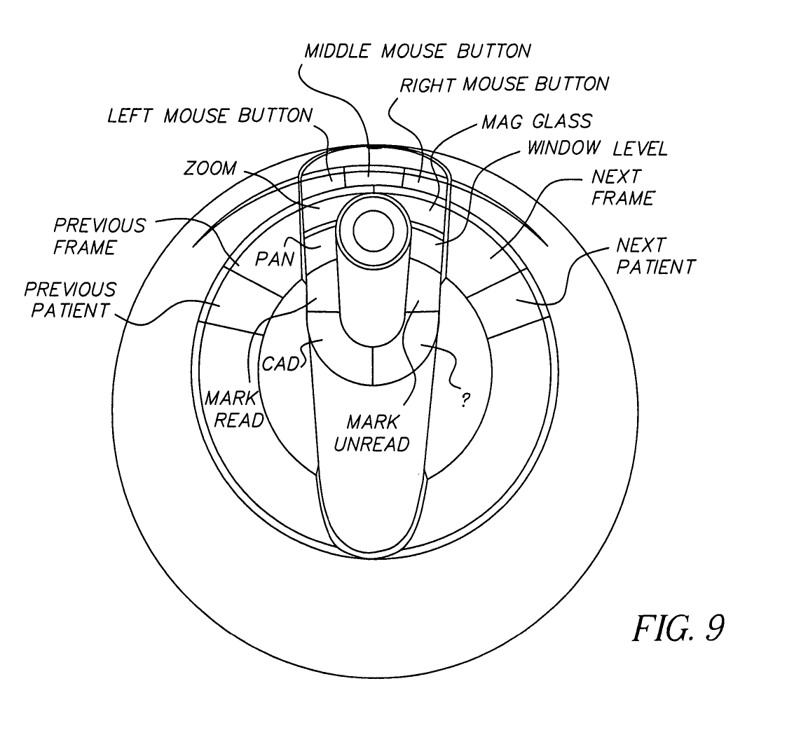

While FIGS. 2 and 3 provide one look as to the shape of controller 10, other suitable shapes can be employed. For example, FIG. 7 illustrates base unit 22 of controller 10 having a more rounded shape as compared to the shape of FIGS. 2 and 3. FIG. 8 shows a further suitable shape. FIG. 9 provides yet a further embodiment.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### PARTS LIST

10 controller
12 medical imaging system
13 network
14 archive device
16 modalities
18 data bases
19 work station
20 hand-held unit
22 base unit
24 cavity
25 electrical connector
30 user control member
32 control member
40 label
41 label
42 control member
44 control member
46 trackball
50 control member
52 backside

1. An independent and integrated centralized high speed system for data management, comprising:
a self-contained communications network for transmitting data across the system;
one or more data acquisition devices operably connectable to the self-contained communications network for recording and transmitting data;
means for transmitting the data across the system; and
a private data processing center interconnectable with the one or more data acquisition devices, and means for transmitting the data across the system, for managing the data.

2. (canceled)

3. An independent and integrated centralized high speed system for data management as provided in claim 1, wherein the self-contained communications network includes at least one private network.

4. An independent and integrated centralized high speed system for data management as provided in claim 3, wherein the at least one private network is an internet protocol private network.

5. An independent and integrated centralized high speed system for data management as provided in claim 1, wherein the one or more data acquisition devices includes one or more data stream processors.

6. An independent and integrated centralized high speed system for data management as provided in claim 1, wherein the transmitting means includes at least one or more switches.

7. An independent and integrated centralized high speed system for data management as provided in claim 1, wherein the one or more data acquisition devices includes one or more cameras.

8. An independent and integrated centralized high speed system for data management as provided in claim 1, wherein the one or more data acquisition devices is equipped to substantially simultaneously record and transmit the data.

9. An independent and integrated centralized high speed system for data management as provided in claim 1, wherein the one or more data acquisition devices is equipped to substantially simultaneously record audio information.

10. An independent and integrated centralized high speed system for data management as provided in claim 1, wherein the one or more data acquisition devices is equipped to compress the data.

11. An independent and integrated centralized high speed system for data management as provided in claim 10, wherein the one or more cameras is equipped to substantially simultaneously record visual information from more than one node on the system.

12. An independent and integrated centralized high speed system for data management as provided in claim 1, wherein the private data processing center includes at least one call manager.

13. An independent and integrated centralized high speed system for data management as provided in claim 1, wherein the private data processing center includes at least one router.

14. An independent and integrated centralized high speed system for data management as provided in claim 1, wherein the private data processing center includes one or more means for conducting data across the private network.

15. An independent and integrated centralized high speed system for data management as provided in claim 1, further comprising one or more voice transmission subsystems operably connectable to the independent communications network.

16. A self-contained method for managing data, comprising:
selecting one or more data acquisition devices;
connecting the one or more data acquisition devices to an independent high speed network;
including at least one central data management subsystem operably connectable to the one or more data acquisition devices and to the independent high speed network for receiving and processing a flow of data across the independent high speed network;
transmitting the data across the independent high speed network without broadband capability; and
processing the data to provide substantially real time information.

17. A self-contained method for managing data as recited in claim 16, wherein the one or more data acquisition devices selecting step includes the substeps of:
installing one or more data stream processors for receiving, recording, and sending the data; and
providing programmable software for transmitting and processing the data.

18. A self-contained method for managing data as recited in claim 16, wherein the one or more data acquisition devices selecting step further includes the substeps of:
selecting at least one camera;
installing the at least one camera on the independent high speed network for providing audio and visual data;
compressing audio and video data;
including means for recording more than one video data stream substantially simultaneously; and
providing software to enable simultaneous recording and viewing of images.

19. A self-contained method for managing data as recited in claim 16, wherein the independent high speed network connecting step includes the substep of interconnecting the one or more data acquisition devices and the at least one central data management subsystem to at least one private network.

20. A self-contained method for managing data as recited in claim 16, wherein the independent high speed network connecting step includes the substep of interconnecting the one or more data acquisition devices and the at least one central data management subsystem to at least one internet protocol private network.

21. A self-contained method for managing data as recited in claim 19, further comprising the substep of disposing at least one telephony subsystem for voice transmission over the independent high speed network.

22. A self-contained method for managing data as recited in claim 21, wherein the at least one central data management subsystem including step includes the substeps of:
receiving the data from more than one source;
collecting the data in one or more machines capable of storing the data;
executing instructions on the data;
transmitting the data to other nodes on the independent high speed network; and
routing incoming data to a data repository;

23. A self-contained method for managing data as recited in claim 22, wherein the data processing step includes the substep of providing software to present the data in human useable format.

24. An apparatus for monitoring a remote site, comprising:
one or more private networks:
one or more data acquisition devices operably connectable to the one or more private networks;
at least one data processing center interconnectable with the one or more private networks and the one or more data acquisition devices;
means for transmitting the data across the system; and
an internet protocol telephony subsystem connectable to the one or more private networks.

25. An apparatus for monitoring a remote site as recited in claim 24, wherein the one or more private networks is capable of transmitting voice data packets across the system.

26. An apparatus for monitoring a remote site as recited in claim 24, wherein the one or more data acquisition devices includes software for substantially simultaneous recording and viewing of data related to images.

27. An apparatus for monitoring a remote site as recited in claim 26, wherein the one or more data acquisition devices is a camera operably connectable to the one or more private networks for receiving, recording, and sending surveillance data across the one or more private networks.

28. An apparatus for monitoring a remote site as recited in claim 27, wherein the one or more data acquisition devices includes means for processing the data across the one or more private networks.

29. An apparatus for monitoring a remote site as recited in claim 24, further comprising an Ethernet switch for transmitting ranges of frequencies.

30. An apparatus for monitoring a remote site as recited in claim 29, further comprising one or more routers.

31. A method for acquiring and processing surveillance information, comprising:
installing at least one independent data transmission system capable of high speed receipt and delivery of data;
connecting at least one surveillance information acquisition device to the independent data transmission system; and
including a plurality of devices interconnectable with the independent data transmission system capable of:
(1) accumulating the surveillance information from the at least one surveillance data acquisition device;
(2) transmitting the surveillance information to a central data management facility;
(3) routing the surveillance information to one or more subsystems for data storage;
(4) storing the surveillance information;
(5) updating the surveillance information;
(6) analyzing surveillance information;
(7) reporting the surveillance information on demand;
(8) providing telephonic communications across the at least one independent data transmission system; and
(9) continually repeating steps (1) through (8).

32. A method for acquiring and processing surveillance information as recited in claim 31, wherein the at least one independent data transmission system installing step includes the substep of installing a system usable with at least private branch exchanges and the Internet.

33. A method for acquiring and processing surveillance information as recited in claim 31, wherein the at least one surveillance data acquisition device connecting step includes the substeps of:
installing one or more data stream processors capable of receiving, recording, and transmitting the surveillance information across the at least one independent data transmission system;
providing software for processing and transmitting the surveillance information across the at least one independent data transmission system;
compressing the surveillance information;
recording and transmitting more than one stream of surveillance information simultaneously; and
recording and viewing the surveillance information substantially simultaneously.

34. A method for acquiring and processing surveillance information as recited in claim 31, further comprising one or more telephony devices connectable to the at least one independent data transmission system.

35. An integrated centralized high speed system for data management of remotely acquired digital data, comprising:
at least one high speed network for transmitting the digital data;
means connectable to the at least one high speed network for acquiring the digital data;
means operably connectable to the digital data acquiring means for transmitting the digital data across the system; and
means for processing the digital data to achieve data management.

36. An integrated centralized high speed system for data management of remotely acquired digital data as recited in claim 35, further comprising one or more subsystems for audio communication.

37. An integrated centralized high speed system for data management of remotely acquired digital data as recited in claim 35, wherein the digital data acquiring means includes at least one camera.

38. An integrated centralized high speed system for data management of remotely acquired digital data as recited in claim 35, wherein the at least one camera records audio and visual signals.

39. An integrated centralized high speed system for data management of remotely acquired digital data as recited in claim 38, wherein the at least one camera substantially simultaneous records and views an interrelated sequence of images.

40. An integrated centralized high speed system for data management of remotely acquired digital data as recited in claim 39, wherein the at least one camera compresses data.

41. An integrated centralized high speed system for data management of remotely acquired digital data as recited in claim 40, wherein the at least one camera records video data from more than one source substantially simultaneously.

42. An integrated centralized high speed system for data management of remotely acquired digital data as recited in claim 41, wherein the independent high speed system for conducting the digital data transmits voice and video data.

43. An integrated centralized high speed system for data management of remotely acquired digital data as recited in claim 42, wherein the receiving and processing means includes one or more cameras equipped to substantially simultaneously record and view the digital data.

44. An integrated centralized high speed system for data management of remotely acquired digital data as recited in claim 34, wherein the digital data acquiring means is at least one data stream processor.

45. An integrated centralized high speed system for data management of remotely acquired digital data as recited in claim 34, wherein the digital data receiving and processing means is a private data processing center.

46. An integrated centralized high speed system for data management of remotely acquired digital data as recited in claim 34, wherein the data management processing means includes at least one switch.
